(19) United States
(12) Patent Application Publication
(10) Pub. No.: US 2014/0150283 A1
(43) Pub. Date: Jun. 5, 2014

(54) INFRARED QUARTZ CONVEYOR DRYER AND METHOD OF USE THEREOF

(71) Applicant: BERGMANN PRECISION, INC., Phoenix, AZ (US)

(72) Inventor: John Bergmann, Scottsdale, AZ (US)

(73) Assignee: BERGMANN PRECISION, INC., Phoenix, AZ (US)

(21) Appl. No.: 13/705,989

(22) Filed: Dec. 5, 2012

(51) Int. Cl. F26B 23/04; F26B 21/12; F26B 3/00; F26B 21/10

(52) U.S. Cl. CPC F26B 23/04; F26B 21/10; F26B 21/12; F26B 3/00
USPC 34/266; 34/572; 34/282

(57) ABSTRACT

A conveyor dryer for curing ink on a substrate is provided. The dryer comprises a dryer body, a housing functionally coupled to the dryer body, the housing and dryer body defining a heat zone, a heating element functionally disposed within the heat zone and configured to provide thermal energy, an infeed extension functionally coupled to the dryer body, such that the infeed extension extends substantially horizontally from the dryer body, a conveyor belt functionally coupled to the infeed extension, the conveyor belt being configured to transition from the infeed extension into the heat zone, and a sensor functionally coupled to the infeed extension and configured to sense the substrate on the conveyor belt, wherein under the condition that the substrate is placed on the conveyor belt, the sensor senses the substrate and results in the dryer transitioning from a standby state to an operational state.

### BACKGROUND

1. Technical Field

This disclosure relates generally to conveyor dryers, and in particular to an infrared quartz conveyor dryer used for curing ink printed onto substrates, such as textiles.

2. State of the Art

The demand for printed patterns and indicia on textiles and other items of clothing, including but not limited to t-shirts, sweat shirts, pajamas, and hats, has increased over the years. As a result, in many instances it is the norm for t-shirts and other casual items of clothing to have printed thereon either wording or other recognizable patterns that are decorative, attractive, informative, or otherwise catch the eye. In some cases, brand names and trademarks are printed directly onto articles of clothing to indicate to all the source of the clothing item. To satisfy this growing demand, mass-production and mass-distribution of screen-printed textiles is required.

To produce a finished printed pattern, or other indicia, on a textile, liquid ink is first applied to the textile (i.e., the substrate) in the pattern desired for that particular substrate. This is done by applying a relatively thin layer of ink onto the substrate, which can usually be accomplished with an industrial screen printing process. The applied ink is typically one of two types—plastisol or a water-based ink. In either case, once the ink is applied, the ink pattern must be dried, or “cured”, to cause the ink to adhere to the substrate and remain thereon.

In industrial applications, the curing process may be accomplished by using a conveyor dryer. The conveyor dryer generally includes a conveyor belt that moves under a heating zone. By placing the substrate onto the conveyor belt, the movement of the conveyor belt transitions the substrate having the applied ink thereon under the heating zone, which causes the temperature of the ink to rise to a temperature at which the components in the ink react and the ink cures. In the case of plastisol, the temperature must be high enough, usually about 300 to 330 degrees F., to cause the molecules of the PVC resin within the plasticizer to cross-link and thereby solidify, or cure. The substrate eventually exits the heating zone, due to the movement of the conveyor belt along its path. After leaving the heating zone, the substrate and the ink cool.

The heating zone may consist of one or more heating elements, such as ceramic heating panels or convection dryers. These heating elements are utilized to bring the heating zone up to a desired temperature and to thereafter maintain that desired temperature while substrates are passed thereunder to cure the ink thereon. In conventional conveyor dryers where ceramic heating panels are used, large quantities of energy and time are needed to bring the heating zone to the desired temperature and to thereafter maintain that temperature for proper curing. Thus, despite the occasions where there may be significant time gaps between substrates being placed on the conveyor belt, the conveyor dryer is nevertheless configured to remain in an active heating operational state to avoid the time delay required to heat the dryer up to operational temperatures. As a result, energy resources are wasted when an empty conveyor belt passes under the active heating zone. Energy resources are wasted not only to power the conveyor dryer and to heat the heating zone, but also to maintain the environment in which the dryer is housed. Moreover, the life-span of the conveyor dryer, including the heating elements, is diminished, as the heating elements and conveyor dryer are always active during operational hours, regardless of the presence, or lack thereof, of a substrate on the conveyor belt. As a result, the operation of conventional conveyor dryers is inefficient, wasteful, and not eco-friendly.

Accordingly, there is a need in the screen printing industry for a conveyor dryer that addresses the problems identified above. Specifically, there is a need for a conveyor dryer that is configured to have the capability to process mass quantities of textile substrates having ink printed thereon and yet reduce wasteful energy consumption and prolong the operational life of the dryer and its components.

### SUMMARY

This disclosure relates generally to conveyor dryers, and in particular to a quartz conveyor dryer used for curing ink printed onto substrates, such as textiles.

An aspect of the present disclosure includes a conveyor dryer for curing ink on a substrate, the dryer comprising a dryer body, a housing functionally coupled to the dryer body, the housing and dryer body defining a heat zone, a heating element functionally disposed within the heat zone and configured to provide thermal energy, an infeed extension functionally coupled to the dryer body, such that the infeed extension extends substantially horizontally from the dryer body, a conveyor belt functionally coupled to the infeed extension, the conveyor belt being configured to transition from the infeed extension into the heat zone, and a sensor functionally coupled to the infeed extension and configured to sense the substrate on the conveyor belt, wherein under the condition that the substrate is placed on the conveyor belt, the sensor senses the substrate and results in the dryer transitioning from a standby state to an operational state.

Another aspect of the present disclosure includes a control unit, wherein the control unit receives a signal from the sensor and based on the signal received transitions the dryer back and forth between the standby state and the operational state.

Another aspect of the present disclosure includes wherein the heating element is a plurality of infrared quartz heating elements arranged at predetermined intervals within the housing.

Another aspect of the present disclosure includes wherein in the standby state the infrared quartz heating elements are not thermally active and the conveyor belt is not moving, and wherein in the operational state the infrared quartz heating elements are thermally active and the conveyor belt is moving.

Another aspect of the present disclosure includes wherein under the condition that the sensor senses the substrate on the conveyor belt, the infrared quartz elements transition from the standby state to the operational state, and the conveyor belt postpones transition from the standby state to the operational state until a predetermined amount of time has expired, at which time the conveyor belt transitions to the operational state.

Another aspect of the present disclosure includes wherein the predetermined amount of time is less than 60 seconds, and may be less than 45 seconds. In other cases, the predetermined amount of time may be less than 30 seconds, and may be between 15 and 20 seconds. In yet other cases, the predetermined amount of time may be about 10 seconds.

Another aspect of the present disclosure includes wherein upon transition to the operational state the conveyor belt is configured to operate for a predetermined interval of time, or to travel for a predetermined distance, and wherein upon expiration of the predetermined interval of time, or upon reaching the predetermined distance, each of the heating elements and the conveyor belt transition from the operational state to the standby state.

Another aspect of the present disclosure includes wherein under the condition that the sensor senses another substrate on the conveyor belt prior to expiration of the predetermined interval of time, or prior to reaching the predetermined distance, the predetermined interval of time resets, or the predetermined distance resets, and the heating elements and the conveyor belt remain in the operational state.

Another aspect of the present disclosure includes the dryer further comprising a temperature control functionally coupled to the heat zone and in communication with the control unit, wherein the temperature control senses the temperature of the heat zone and the control unit cycles the infrared quartz heating elements off and on during the operational state to maintain a predetermined temperature within the heat zone.

Another aspect of the present disclosure includes the dryer further comprising a recirculation fan coupled to the dryer body and in fluidic communication with the heat zone, the recirculation fan being configured to circulate air within the heat zone, and an exhaust unit coupled to the housing and configured to exhaust the heat zone, wherein under the condition that the conveyor belt is in the operational state, the control unit transitions the recirculation fan and the exhaust unit from the standby state to the operational state.

Another aspect of the present disclosure includes the dryer further comprising a hood panel that is releasably coupled to the housing and covers the heating element, and a reflector shield functionally coupled to the housing between the hood panel and the heating element to reflect the thermal energy of the heating element toward the conveyor belt passing thereunder.

Another aspect of the present disclosure includes a method of curing ink on a textile substrate, the method comprising providing a conveyor dryer having a conveyor belt and a heating element in a heat zone, sensing the textile substrate on the conveyor belt by a sensor, transitioning the dryer from a standby state to an operational state upon the sensing the textile substrate, and curing the ink on the textile substrate in the operational state.

Another aspect of the present disclosure includes thermally activating the heating element to heat the heat zone upon the sensing the textile substrate.

Another aspect of the present disclosure includes the conveyer belt waiting a predetermined amount of time upon the sensing the textile substrate prior to moving through the heat zone.

Another aspect of the present disclosure includes the conveyor belt moving the textile substrate through the heating zone for a predetermined interval of time sufficient to cure the ink on the textile substrate. Similarly, the conveyor belt may move the textile substrate through the heating zone for a predetermined distance sufficient to ensure that the textile substrate exits the heating zone.

Another aspect of the present disclosure includes maintaining the heating zone within a predetermined temperature range during the operational state.

Another aspect of the present disclosure includes cycling the heating element on and off during the operational state.

Another aspect of the present disclosure includes transitioning the dryer from the operational state to the standby state upon expiration of the interval of time or upon reaching the predetermined distance.

Another aspect of the present disclosure includes maintaining the operational state of the dryer under the condition that the sensor senses another textile substrate on the conveyor belt prior to the expiration of the interval of time, or prior to traveling the predetermined distance.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 is a perspective view of an embodiment of the conveyor dryer in accordance with the present disclosure.

FIG. 2 is a perspective view of an embodiment of the conveyor dryer in accordance with the present disclosure.

FIG. 3 is a perspective view of an embodiment of a component of the conveyor dryer in accordance with the present disclosure.

FIG. 4 is a perspective view of an embodiment of a component of the conveyor dryer in accordance with the present disclosure.

FIG. 5 is a perspective view of an embodiment of a component of the conveyor dryer in accordance with the present disclosure.

FIG. 6 is a bottom perspective view of an embodiment of a component of the conveyor dryer in accordance with the present disclosure.

FIG. 7 is a side view of an embodiment of the conveyor dryer in accordance with the present disclosure.

FIG. 8 is a front view of an embodiment of the conveyor dryer in accordance with the present disclosure.

FIG. 9 is a schematic view of an embodiment of the conveyor dryer in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

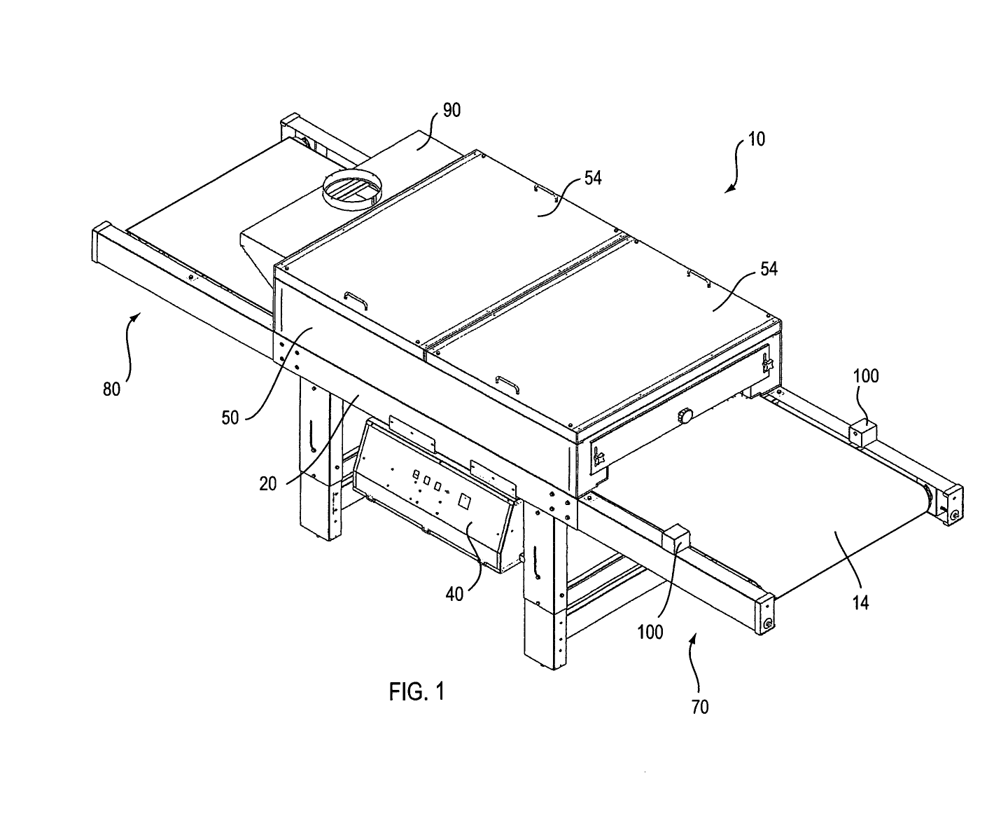

Referring to the drawings, FIG. 1 depicts a conveyor dryer 10 of the present disclosure. The conveyor dryer 10 may comprise a central body 20, a control unit 40, a housing 50, an infeed extension 70, an outfeed extension 80, an exhaust unit 90, and a sensor 100, among other components to be discussed herein. The conveyor dryer 10 of the present invention is configured to provide sufficient heat to dry, or otherwise cure, ink systems that have been placed on substrates and other mediums, such as textiles, apparel and clothing items, just to name a few examples. The dryer 10 of the present invention is configured to be capable of efficiently and cost-effectively mass-producing such items.

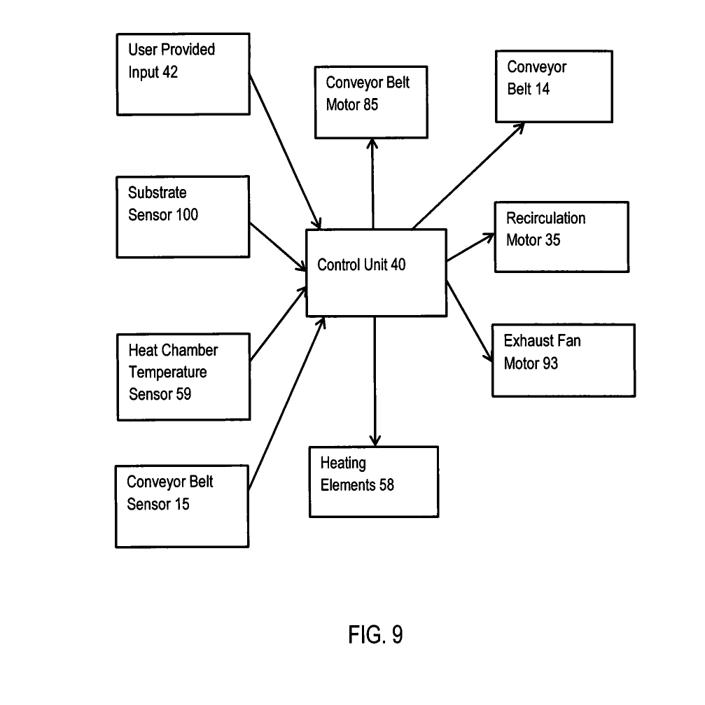

Embodiments of the dryer 10 may comprise a control unit 40 that functions to govern, monitor, control, coordinate, and otherwise administrate the operations of the dryer 10. The control unit 40 and the dryer 10 may utilize a state of the art micro-processor and solid state electronics to accurately maintain the temperature in the heat chamber 52. Further, the control unit 40 may comprise a processor (CPU), an internal storage unit, random access memory (RAM), software programs, a motherboard, a video card, a sound card, and a speaker, among other components. The control unit 40 herein described is configured to control the operational aspects of the dryer 10. For example, the software programs may be computer programs that are developed and configured to operate the dryer 10 according to its intended operation, as described herein. As represented in FIG. 9, the control unit 40 may be configured to receive user-provided input 42 through the interface on the control unit 40. The control unit 40 may be further configured to receive signals from various sensors on the dryer 10, including but not limited to the substrate sensor 100 and the temperature sensor 59 in the heat chamber 58. Once received, the control unit 40 may use the signals to maintain, change, amend, suspend, or otherwise control the various operations of the dryer 10 as described herein.

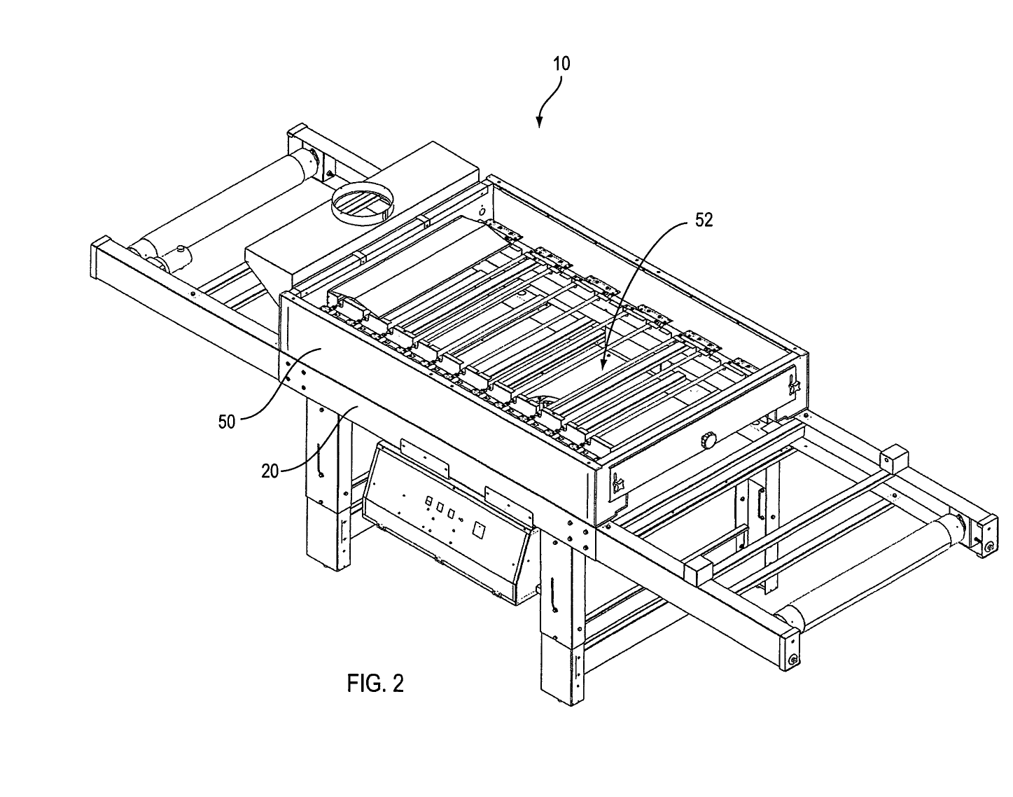

Referring to FIG. 2, embodiments of the dryer 10 may comprise a central body 20 and a housing 50, the housing 50 being positioned generally over the central body 20. The housing 50 may be functionally coupled to the central body 20 such that the housing 50 and the central body 20 complement one another and structurally communicate with one another. The housing 50 may further comprise one or more hood panels 54 that may be configured to functionally engage the housing 50. The hood panels 54 may be configured to be releasably and repeatedly coupled to the housing 50 to cover or uncover, as the case may be, the interior components of the housing 50 and the central body 20, as will be discussed in further detail below. As depicted in FIG. 2, the interior components of the housing 50 and the central body 20 are uncovered with the hood panels 54 removed from the housing 50. The central body 20 and the housing 50 may be configured to define therebetween a heat zone, or heat chamber 52.

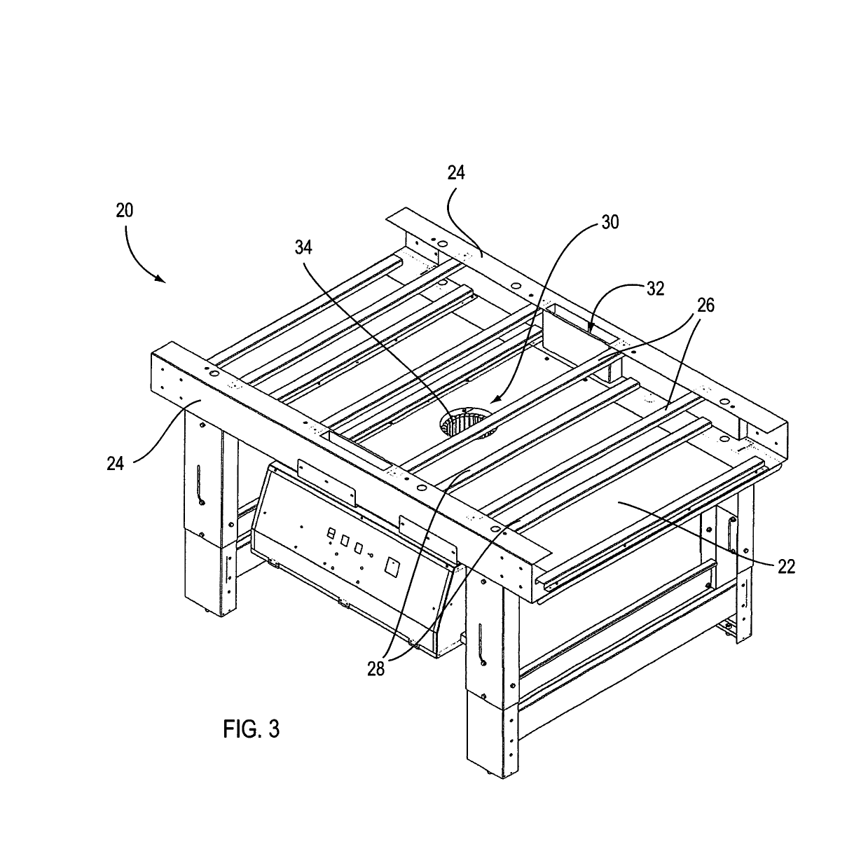

Referring to FIG. 3, embodiments of the dryer 10 may further comprise the central body 20 having a bottom plate 22 that may function as the lower barrier of the heat chamber 52, the hood panels 54 functioning as the upper barrier. The central body 20 may further comprise sidewalls 24 that define the interior region of the central body and thus the heat chamber 52. The bottom plate 22 and sidewalls 24 may be insulated to assist in retaining the heat within the heat chamber 52. The sidewalls 24 may also function to support and receive support from the upper secondary supports 26 and the lower secondary supports 28. The upper secondary supports 26 not only provide structure and rigidity to the sidewalls 24 and thus the central body 20, but also serve to support the conveyor belt 14 that travels over the upper secondary supports 26. The lower secondary supports 28 function not only to provide structure and rigidity to the sidewalls 24 and thus the central body 20, but also to prevent the conveyor belt 14 from displacing as it travels under the lower secondary supports 28. Thus, there is provided a gap between upper and lower portions of the conveyor belt 14 as it travels back and forth in the dryer 10, to be discussed in greater detail herein.

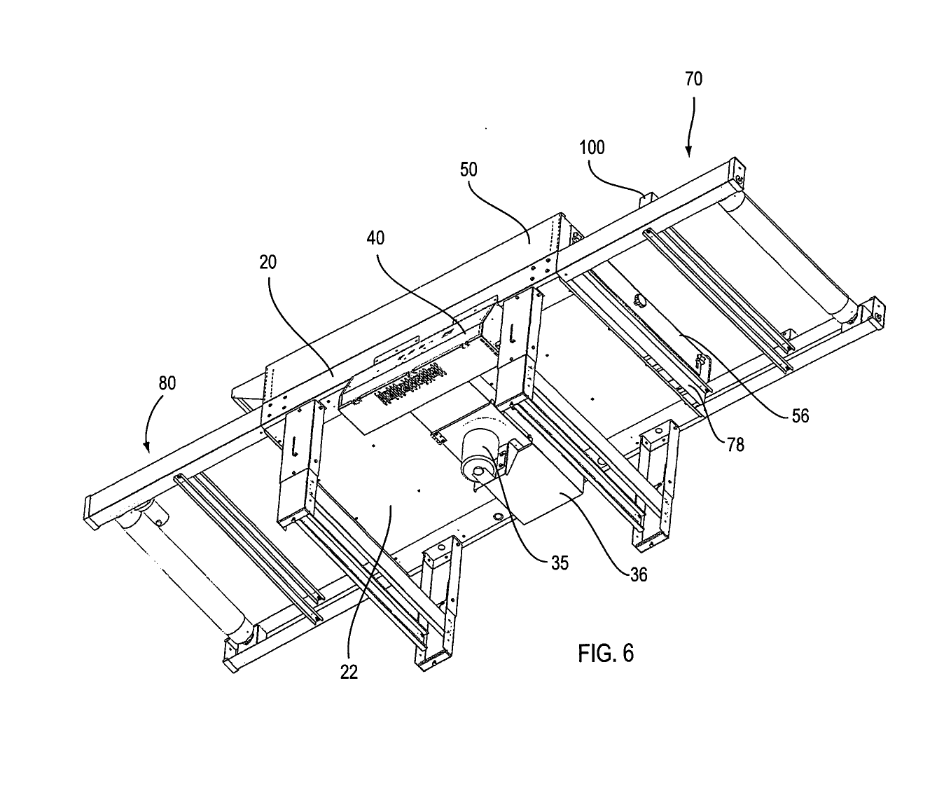

Embodiments of the dryer 10 may further comprise the central body 20 having a recirculation inlet 30 positioned centrally in the bottom plate 22. The inlet 30 may be positioned in other areas of the bottom plate 22, but the central position provides the greatest advantages. The inlet 30 may be configured to have attached thereto a recirculation fan 34 driven by its own recirculation motor 35, see FIG. 6, that draws air from underneath the lower portion of the conveyor belt 14 into the recirculation chamber 36, see FIG. 6, and thereafter forces this air back into the heat chamber 52 through one or more recirculation outlets 32 which may be positioned in the sidewalls 24 of the central body 20. With this configuration, air that has been previously heated in the heat chamber 52 and that may have cooled slightly and settled at the bottom of the central body 20 near the bottom plate 22 may be drawn down into the inlet 30 by the fan 34. The fan 34 may then force this air through the recirculation chamber 36 and out of the outlets 32 and back into the upper regions of the heat chamber 52 near the heating elements 58 to be heated once more. In this way, the heat chamber 52 is much more efficient, as the preheated air is conserved and reintroduced back into the heat chamber 52, instead of the heat chamber 52 having to always heat ambient air from outside the heat chamber 52.

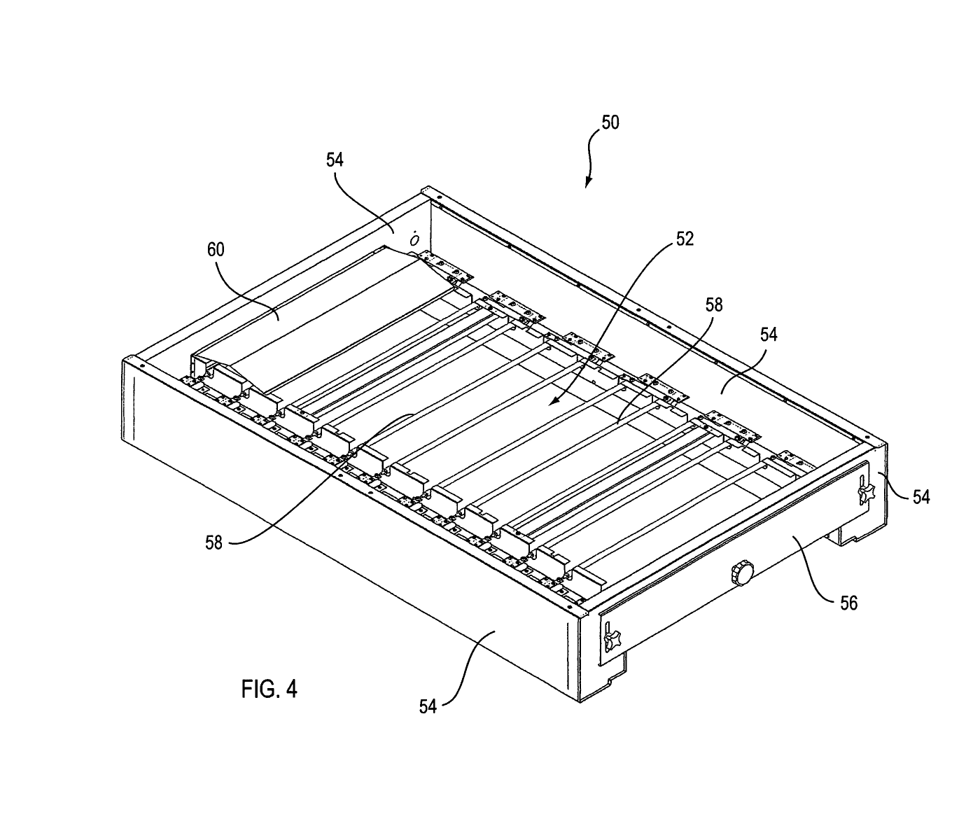

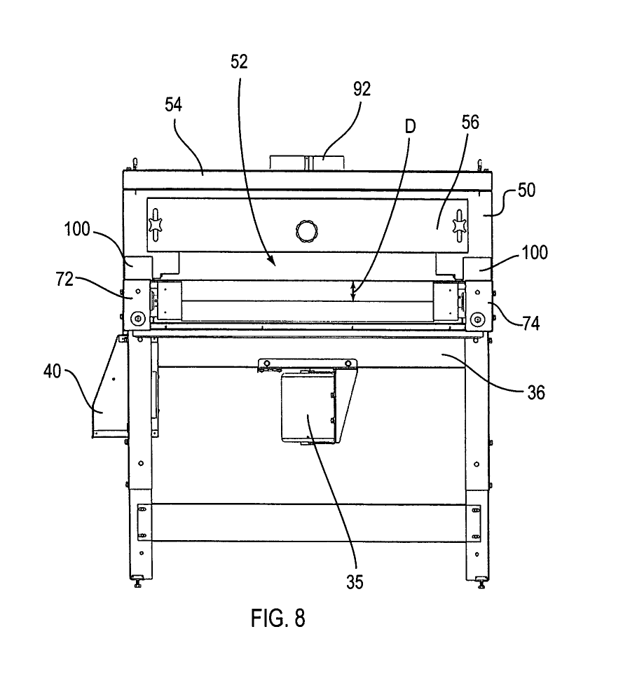

Referring to FIG. 4, embodiments of the dryer 10 may further comprise the housing 50 having sidewalls 54 that define the interior region of the housing 50 and thus the heat chamber 52. The sidewalls 54 may be insulated to assist in retaining the heat within the heat chamber 52. The housing 50 may further comprise a door 56 that may be adjustable, at least vertically, with respect to the housing 50. In this way, the door 56 may be moved up and down to accommodate the different thickness of articles of clothing that might be placed on the conveyor belt 14. Sweatshirts may be thicker than t-shirts, and thus the door 56 may need to be raised with respect to the housing 50 to permit the sweatshirt to move with the conveyor belt 14 under the door 56 and into the heat chamber 52. The door 56 may also be adjusted to be just high enough to permit the article of clothing, the textile, or other substrate to pass freely thereunder but yet retain as much heat as possible within the heat chamber 52. The front and back sides of the housing 50 may have a door 56 functionally coupled thereto to provide this advantage. As depicted in FIG. 8, embodiments of the dryer 10 may include a distance D between the top portion of the conveyor belt 14 and the lower edge portion of the door 56. Of course, as described above, this distance D may be adjusted, as needed, by the user.

Embodiments of the dryer 10 may further comprise the housing 50 having one or more heating elements 58 functionally coupled thereto. The heating elements 58 may provide thermal energy to the heat chamber 52 to raise the internal temperature of the heat chamber 52 to a predetermined desired operational temperature or to maintain the internal temperature of the heat chamber 52 within a predetermined operational temperature range. The heating elements 58 may convert electrical energy to thermal energy. For example, the heating elements 58 may be infrared quartz bulbs that convert electrical energy to thermal energy. Infrared quartz bulbs emit infrared electromagnetic waves which, when striking and absorbed by an object, cause the objects temperature to rise. Thus, under the condition that the heating elements 58 are infrared quartz bulbs, the heating elements 58 may emit medium wave infrared electromagnetic waves that function to heat up the substrate, textile, or clothing item placed on the conveyor belt 14 and is thereby introduced into the heat chamber 52. The infrared quartz bulb heating element 58 may achieve an appropriate level of thermal energy output to cure ink systems on the substrate placed on the conveyor belt 14 in the dryer 10 in a relatively short amount of time. For example, the infrared quartz bulb heating elements 58 may achieve an appropriate level of thermal energy output in the neighborhood of less than 60 seconds. In other cases, the time to achieve an appropriate level of thermal energy output from the infrared quartz bulb heating elements 58 may be less than 45 seconds. In yet other cases, the time for the infrared quartz bulb heating elements 58 to achieve an appropriate level of thermal energy output to cure ink systems in the dryer 10 may be less than 30 seconds, may be between 15 and 20 seconds, and may be as little as 10 seconds. At any rate, the time it takes for the quartz bulb heating elements 58 to reach an appropriate level of thermal energy to cure ink systems on substrates passing on the conveyor belt 14, is much less than other conventional ceramic heating panel conveyor dryers. This shorter ramp-up time for the heating elements 58 of the dryer 10 is significant and provides advantages over slower performing conventional conveyor dryers, which will be discussed herein.

Embodiments of the dryer 10 may further comprise the heat chamber 52 having a temperature sensor 59 functionally coupled thereto for monitoring the temperature of the heat chamber 52. The temperature of the heat chamber 52 may be determined by the user and input into the control unit 40. Thereafter, the control unit 40 may control the operation of the heating elements 58 within the heat chamber 52. For example, initially, the heating elements 58 may be in a standby state, wherein the heating elements 58 are not thermally active. The control unit 40 may transition the heating elements 58 from this standby state to an operational state, in which the heating elements 58 are thermally active. The control unit 40 may determine to transition the heating elements 58 from the standby state to the operational state based on user input 42 or sensor input. Moreover, in the operational state the control unit 40 may cycle the heating elements 58 between on and off positions, or standby and operational positions, to maintain the temperature within the heat chamber 52 at the predetermined temperature or within a predetermined temperature range. The temperature sufficient to cure the ink systems on the substrates, mediums, textiles, and other items introduced into the heat chamber 52 can be between 300 and 330 degrees F. However, the user may adjust the temperature for the specific item introduced into the heat chamber 52 and for the specific ink system to be cured thereby.

Embodiments of the dryer 10 may further comprise a “flash” feature, wherein the first several of the heating elements 58 positioned from the front of the housing 50 remain constantly thermally active once transitioned to the operational state. By being constantly thermally active, these first several heating elements 58 provide high thermal energy at the front entrance of the heat chamber 52. The remaining heating elements 58, that are positioned behind the first several heating elements 58, may cycle between the on and off positions, or between the standby and operational states, as directed by the control unit 40 from user input 42 or sensor input. As such, the cycling of these remaining heating elements 58 between the on and off positions, or between the standby and operational states, may allow these remaining heating elements 58 to maintain a lower temperature than the relatively high temperature of the first several heating elements 58. When active, the “flash” feature serves to provide high initial heat, due to the constant thermal activity of the first several heating elements 58, on the substrates, mediums, textiles, or other articles of clothing that initially enter the heat chamber 52 on the conveyor belt 14 to bring these items quickly up to the required heat to cure the ink system thereon. The remaining heating elements 58 may then apply consistent thermal energy at the predetermined temperature to the substrate, medium, textile, or other article of clothing that continues through the heat chamber 52 on the conveyor belt 14

Heating elements 58 of the type described herein, such as the medium-wave infrared quartz elements, can be obtained through manufacturers of infrared quartz tubes or bulbs, GLO-QUARTZ® Incorporated being an example of such a provider.

Embodiments of the dryer 10 may further comprise a reflector 60 configured within the housing 50 and over the heating elements 58, as depicted in FIG. 4. The reflector 60 may be placed over one or more heating elements 58 to direct the thermal energy of the infrared electromagnetic waves down onto the conveyor belt 14 and any substrate placed thereon. The conveyor belt 14 passes below the heating elements 58. The reflector 60 may be positioned between the heating elements 58 and the removable hood panels 54. A plurality of reflectors 60 may be utilized to cover each of the heating elements 58 in the housing 50. In other words, for each pair of heating elements 58, a v-shaped reflector 60 may be placed thereover to direct the thermal energy down toward the conveyor belt 14.

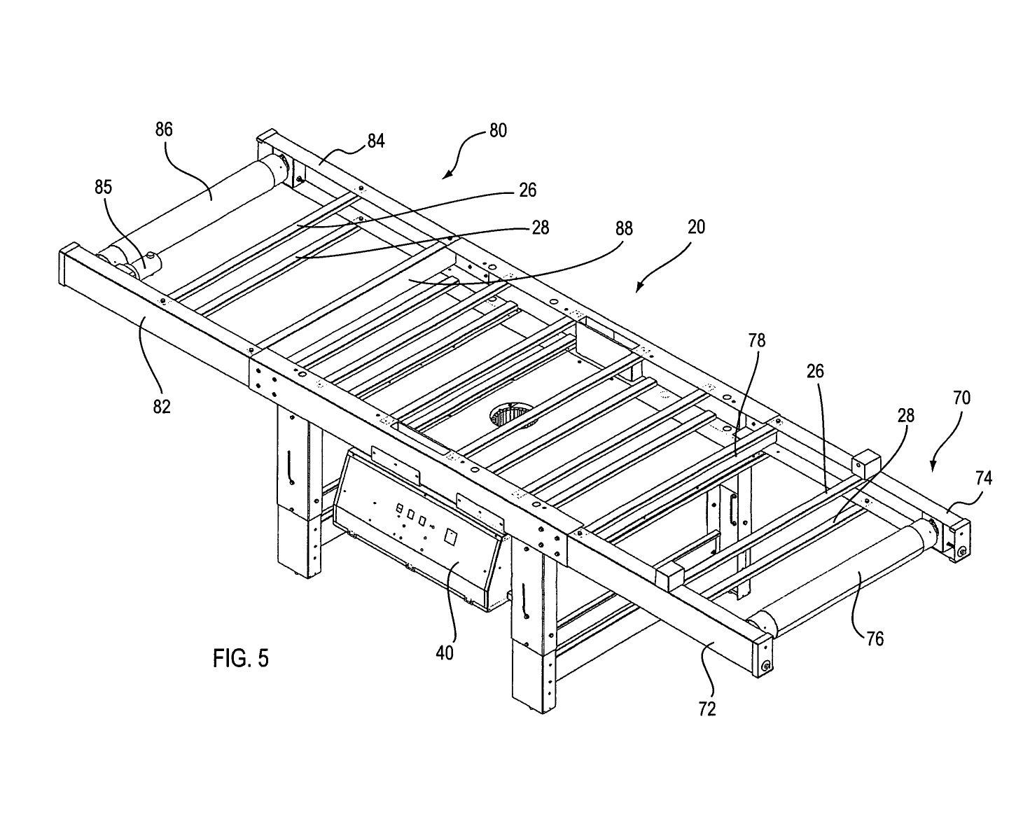

Referring now to FIG. 5, embodiments of the dryer 10 may further comprise an infeed extension 70 and an outfeed extension 80. Each of the infeed extension 70 and the outfeed extension 80 may be configured to be functionally coupled to the central body 20, such that the infeed extension 70 protrudes substantially horizontally from the front end of the central body 20 and the outfeed extension 80 protrudes substantially horizontally from the back end of the central body 20. The infeed extension 70 and the outfeed extension 80 may be configured to receive and functionally engage the conveyor belt 14 and maintain the conveyor belt 14 along its designated path. Positional sensors 15 may be functionally coupled to the infeed extension 70 and the outfeed extension 80 to monitor the position of the conveyor belt 14 with respect to its designated path. If the conveyor belt 14 deviates too much from its designated path, the positional sensors 15 may send a signal to the control unit 40 and the control unit 40 may instruct the dryer 10 to cease operation or may alert the user of the potential problem so that the problem may be addressed.

Embodiments of the dryer 10 may further comprise the infeed extension 70 having a first arm 72 and a corresponding second arm 74. At the distal end of the arms 72 and 74 a belt roller 76 may be positioned therebetween to engage and functionally carry the conveyor belt 14, the conveyor belt 14 being configured to wrap around the roller 76. At the opposing end of the arms 72 and 74, a heat barrier 78 may be positioned therebetween to not only prevent heat from escaping the heat chamber 52, under the condition the infeed extension 70 is coupled to the central body 20, but also to provide sufficient and rigid support to the arms 72 and 74 as they connect to the central body 20. Similarly, embodiments of the dryer 10 may further comprise the outfeed extension 80 having a first arm 82 and a corresponding second arm 84. At the distal end of the arms 82 and 84 a belt driver 86 may be positioned therebetween to drive the conveyor belt 14 that may be configured to wrap around the driver 86. The driver 86 may be functionally coupled to a belt driver motor 85 that receives operational input from the control unit 40. In this way, as the control unit 40 provides input to the belt driver motor 85, which provides rotational movement to the belt driver 86, the belt driver motor 85 may control the operational speed and timing of the conveyor belt 14 that is functionally engaged by the belt driver 86. The operational speed of the belt driver motor 85 may be adjusted according to user input or sensor input, as will be described herein. At the opposing end of the arms 82 and 84, a heat barrier 88 may be positioned therebetween to not only prevent heat from escaping the heat chamber 52, under the condition the outfeed extension 80 is coupled to the central body 20, but also to provide sufficient and rigid support to the arms 82 and 84 as they connect to the central body 20. Each of the infeed extension 70 and the outfeed extension 80 may also comprise upper secondary supports 26 and lower secondary supports 28 to provide support to the conveyor belt 14 and also to each of the respective pairs of arms, 72 and 74, and 82 and 84.

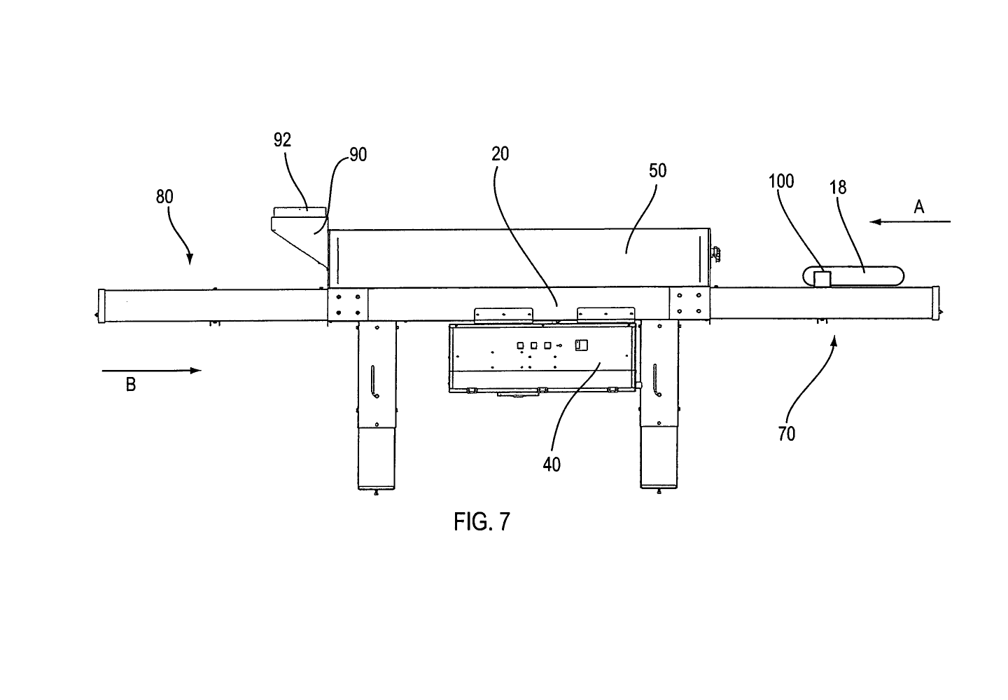

Referring now to FIG. 7, the infeed extension 70 may be configured to receive a substrate placed thereon for entrance into the heat chamber 52, as the top portion of the conveyor belt 14, upon which substrates are placed, operates in the direction of arrow A. In like manner, the bottom portion of the conveyor belt 14, which returns from the outfeed extension 80 back to the infeed extension 70, operates in the direction of arrow B. Each of the top portion of the conveyor belt 14 and the bottom portion of the conveyor belt 14 are configured to pass through the heat chamber 52.

Embodiments of the dryer 10 may further comprise an exhaust unit 90, the exhaust 90 being functionally coupled to the housing 50 at the exit end of the housing 50, or, in other words, at the end of the housing 50 proximate the outfeed extension 80. The exhaust unit 90 may be configured in the form of an oven hood, the hood having an exhaust port 92 positioned centrally therein. The exhaust port 92 may be functionally coupled to a fan and corresponding motor 93 and other duct work exterior to the dryer 10 that assists in exhausting heat chamber fumes out of the environment in which the dryer 10 is configured. As the ink systems cure within the heat chamber 52, fumes and other gases may be released into the heat chamber 52. As the substrates move out of the heat chamber 52 and onto the outfeed extension 80 along the conveyor belt 14, the substrates draw these fumes and other gases out of the heat chamber 52. The exhaust unit 90 may be configured to capture these fumes and gases and exhaust them out through the exhaust port 92 and out of the environment in which the dryer 10 is configured. The control unit 40 may be configured to control the fan 93 that is functionally coupled to the exhaust unit 90, such that the control unit 40 directs the operational aspects of the exhaust unit 90.

Embodiments of the dryer 10 may further comprise a substrate sensor 100. The substrate sensor 100 may be functionally configured on the infeed extension 70 to be able to sense the placement, or lack thereof as the case may be, of a substrate 18 on the conveyor belt 14 that is over the infeed extension 70. The sensor 100 may be configured to communicate a signal to the control unit 40 as to the presence, or lack thereof, of the substrate 18 on the conveyor belt 14. The substrate sensor 100 may be an optical sensor with light, photo diodes with UV rays or x-rays, laser emitter with a detector, infrared, fiber optic, proximity detector, pyrometer, or any sensor now know or later developed that functions according to the disclosure herein. Once a substrate 18 is placed on the conveyor belt 14 on the infeed extension 70, the substrate sensor 100 will be triggered, thus sending a signal to the control unit 40 that a substrate 18 has been placed on the conveyor belt 14.

The substrate sensor 100 may be positioned on the dryer 10 at any position that allows the sensor 100 to detect the presence or lack thereof, of the substrate on the conveyor belt 14. For example, the sensor 100 may be placed on the infeed extension 70, either above or below the upper portions of the conveyor belt 14, to thus sense the presence of the substrate 18 thereon. Further in example, a plurality of sensors 100 may be placed at various positions along the infeed extension 70, either above or below the upper portions of the conveyor belt 14, to thus sense the presence of the substrate 18 thereon. Any of the sensors 100, or pairs of sensors, as the case may be, may sense the presence of the substrate 18 and send the signal to the control unit 40 to commence the operational states of the various components of the dryer 10 as described herein. Any of the sensors 100 may be adjustable on the infeed extension 70 at any point along the direction of travel of the conveyor belt 14 according to user preference, to thus accommodate large or small substrates 18 being placed on the conveyor belt 14. Moreover, the sensitivity of the sensor 100 may be adjustable according to user preference and may be adjustable via direct adjustment to the sensor 100 or via adjustment through the control unit 40. In other words, the control unit 40 may be used by the user to adjust the sensitivity of the sensing of any of the sensors 100.

The substrate sensor 100 may also be a force sensor configured to sense the tension and/or pressure placed on the conveyor belt 14 due to the weight of the substrate 18 being placed on the conveyor belt 14.

Embodiments of the dryer 10 may further comprise the control unit 40 configured to operate a method of use of the dryer 10. Specifically, the control unit 40 may transition the various components of the dryer 10 between a standby state and an operational state. For example, the control unit 40 may be configured to control the operation aspects of at least the heating elements 58, the conveyor belt 14, the recirculation motor 35, and the exhaust motor 93 to turn these components on and off, or to transition between the standby state and the operational state, and to adjust the operational conditions of these components. In the standby state, electrical power may be provided to the dryer 10, such that the control unit 40 is operational and the substrate sensors 100 are operational. However, in the standby state, the heating elements 58 may be thermally inactive, the conveyor belt 14 may not be moving (i.e., the belt drive motor 85 may be inactive), and the circulation motor 35 and the exhaust motor 93 may also be inactive. On the other hand, in the operational state, the heating elements 58 may be thermally active, the conveyor belt 14 may be moving (i.e., the belt drive motor 85 may be active), and the circulation motor 35 and the exhaust motor 93 may also be active.

Nevertheless, the timing of the transition between the standby state and the operational states of each of these components may be controlled by the control unit 40. For example, under the condition that a substrate 18 is placed on the conveyor belt 14 to trigger the substrate sensor 100, the substrate sensor 100 sends a signal to control unit 40 to begin transitioning the various components from their respective standby state to their respective operational state. As soon as the control unit 40 receives the signal that the substrate 18 has been placed on the conveyor belt 14, the control unit instructs the heating elements to transition from the standby state to the operational state. Thus, upon placement of the substrate 18 on the conveyor belt 14 to be sensed by the substrate sensor 100, the heating elements 58 thermally activate and begin to reach the appropriate thermal capacity. In the meantime, the control unit 40 instructs the conveyor belt 14, and thus the belt drive motor 85, to wait a predetermined amount of time before transitioning from the standby state to the operational state. Embodiments of the dryer 10 may include the predetermined amount of time being less than 60 seconds, whereas other embodiments may include the predetermined amount of time being less than 45 seconds, whereas other embodiments may include the predetermined amount of time being between 15 and 20 seconds and even as little as 10 seconds. At any rate, the predetermined amount of time should be approximate to the amount of time it takes the heating elements 58 to reach an adequate level of thermal energy output, or to raise the temperature in the heat chamber 52 to an adequate temperature to cure the ink system on the specific substrate 18. The user may input to the control unit 40 the predetermined amount of time the conveyor belt 14 is to wait after the substrate sensor 100 has sensed the presence of the substrate 18 prior to transitioning from its standby state to its operational state. The predetermined amount of time is adjustable by the user via the control unit 40.

Once the predetermined amount of time has elapsed, the control unit 40 may instruct the belt driver motor 85 to transition from the standby state to the operational state to thus begin moving the conveyor belt 14, such that the upper portion of the conveyor belt 14 on the infeed extension 70 begins to move toward the heat chamber 52. The control unit 40 thereafter instructs the belt driver motor 85 and thus the conveyor belt 14 to remain in the operational state for a predetermined interval of time or, in the alternative, for a predetermined distance of travel to allow the substrate 18 to enter and exit the heat chamber 52. In any event, the predetermined interval of time or the predetermined distance of travel should be enough to permit the substrate 18 to pass completely through the heat chamber 52 and exit out onto the upper portion of the conveyor belt 14 on the outfeed extension 80. The user may input to the control unit 40 the predetermined interval of time or the predetermined distance the conveyor belt 14 is to operate or travel, respectively, after the conveyor belt 14 has transitioned to the operational state. The predetermined interval of time and/or the predetermined distance is adjustable by the user via the control unit 40.

In addition, once the control unit 40 instructs the conveyor belt 14 to transition to the operational state, the control unit 40 may also instruct the recirculation motor 35 and the exhaust motor 93 to transition from their respective standby states to their respective operational states, wherein the recirculation motor 35 causes the recirculation fan 34 to recirculate preheated air from the heat chamber 52 back into the heat chamber 52 and wherein the exhaust motor 93 begins to draw out the fumes and gases from within the heat chamber 52. Moreover, in the operational state, the control unit 40 may further instruct the various heating elements 58 to periodically cycle between an on and off position, or between a standby state and an operational state, to control and/or maintain the temperature within the heat chamber 52, as measured by the temperature sensor 59 and communicated to the control unit 40, to at or nearly at the user-input predetermined temperature or within the user-input temperature range.

Embodiments of the dryer 10 may further comprise the control unit 40 transitioning each of the heating elements 58, the conveyor belt 14, the recirculation motor 35, and the exhaust motor 93 from the operational state back to the standby state once the substrate 18 has been processed by the dryer 10. For example, under the condition that the conveyor belt 14 operates for the entire predetermined time interval or the conveyor belt 14 travels the predetermined distance of travel, the control unit 40 may instruct the heating elements 58, the conveyor belt 14, the recirculation motor 35, and the exhaust motor 93 to transition from the operational state back to the standby state. However, prior to doing so, the control unit 40 checks to see if another signal has been sent from the substrate sensor 100 to inform the control unit 40 that another substrate 18 has been placed on the conveyor belt 14. If another substrate 18 has been placed on the conveyor belt 14 to be introduced into the heat chamber 52, the predetermined time interval resets or the predetermined distance of travel resets so that the newly introduced substrate 18 can be effectively processed by the dryer 10. On the other hand, if the sensor 100 does not sense another substrate 18, then the control unit 40 instructs the heating elements 58, the conveyor belt 14, the recirculation motor 35, and the exhaust motor 93 to transition from the operational state back to the standby state. In this way, the operational states of the various components of the dryer 10 may be activated when a substrate 18 is introduced onto the dryer 10 and is sensed by the substrate sensor 100. If no substrate 18 is introduced onto the dryer 10, or once the last substrate 18 has been processed by the dryer 10, then the dryer 10 may conserve energy by transitioning back to the standby state and remaining therein until a new substrate 18 is introduced onto the conveyor belt 14 and is sensed by the substrate sensor 100. Then, the process and method described above commences again. The process is repeatable over and over and serves to conserve energy used by the dryer 10 and extends the life span of the various dryer components.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A conveyor dryer for curing ink on a substrate, the dryer comprising:
a dryer body;
a housing functionally coupled to the dryer body, the housing and dryer body defining a heat zone;
a heating element functionally disposed within the heat zone and configured to provide thermal energy;
an infeed extension functionally coupled to the dryer body, such that the infeed extension extends from the dryer body;
a conveyor belt functionally coupled to the infeed extension, the conveyor belt being configured to transition from the infeed extension into the heat zone; and
a sensor functionally coupled to the dryer and configured to sense the substrate on the conveyor belt,
wherein under the condition that the substrate is placed on the conveyor belt, the sensor senses the substrate and results in the dryer transitioning from a standby state to an operational state.

2. The dryer of claim 1, further comprising a control unit, wherein the control unit receives a signal from the sensor and based on the signal received transitions the dryer back and forth between the standby state and the operational state.

3. The dryer of claim 2, wherein the heating element is a plurality of infrared quartz heating elements arranged at predetermined intervals within the housing.

4. The dryer of claim 3, wherein in the standby state the infrared quartz heating elements are not thermally active and the conveyor belt is not moving, and wherein in the operational state the infrared quartz heating elements are thermally active and the conveyor belt is moving.

5. The dryer of claim 4, wherein under the condition that the sensor senses the substrate on the conveyor belt, the infrared quartz elements transition from the standby state to the operational state, and the conveyor belt postpones transition from the standby state to the operational state until a predetermined amount of time has expired, at which time the conveyor belt transitions to the operational state.

6. The dryer of claim 5, wherein the predetermined amount of time is 60 seconds or less.

7. The dryer of claim 5, wherein upon transition to the operational state the conveyor belt is configured to operate for a predetermined interval of time, and wherein upon expiration of the predetermined interval of time each of the heating elements and the conveyor belt transition from the operational state to the standby state.

8. The dryer of claim 6, wherein under the condition that the sensor senses another substrate on the conveyor belt prior to expiration of the predetermined interval of time, the predetermined interval of time resets and the heating elements and the conveyor belt remain in the operational state.

9. The dryer of claim 4, the dryer further comprising:
a temperature control functionally coupled to the heat zone and in communication with the control unit, wherein the temperature control senses the temperature of the heat zone and the control unit cycles the infrared quartz heating elements off and on during the operational state to maintain a predetermined temperature within the heat zone.

10. The dryer of claim 5, the dryer further comprising:
a recirculation fan coupled to the dryer body and in fluidic communication with the heat zone, the recirculation fan being configured to circulate air within the heat zone; and
an exhaust unit coupled to the housing and configured to exhaust the heat zone,
wherein under the condition that the conveyor belt is in the operational state, the control unit transitions the recirculation fan and the exhaust unit from the standby state to the operational state.

11. The dryer of claim 1, the dryer further comprising:
a hood panel that is releasably coupled to the housing and covers the heating element; and
a reflector shield functionally coupled to the housing between the hood panel and the heating element to reflect the thermal energy of the heating element toward the conveyor belt passing thereunder.

12. A method of curing ink on a textile substrate, the method comprising:
providing a conveyor dryer having a conveyor belt and a heating element in a heat zone;
sensing the textile substrate on the conveyor belt by a sensor;
transitioning the dryer from a standby state to an operational state upon the sensing the textile substrate; and
curing the ink on the textile substrate in the operational state.

13. The method of claim 12, the transitioning the dryer from a standby state to an operational state further comprises thermally activating the heating element to heat the heat zone upon the sensing the textile substrate.

14. The method of claim 12, the transitioning the dryer from a standby state to an operational state further comprises the conveyer belt waiting a predetermined amount of time upon the sensing the textile substrate prior to moving through the heat zone.

15. The method of claim 14, wherein the predetermined time is 60 seconds or less.

16. The method of claim 12, the curing the ink on the textile substrate in the operational state further comprises the conveyor belt moving the textile substrate through the heating zone for a predetermined interval of time sufficient to cure the ink on the textile substrate.

17. The method of claim 13, the method further comprising maintaining the heating zone within a predetermined temperature range during the operational state.

18. The method of claim 17, the maintaining the heating zone within a predetermined temperature range further comprises cycling the heating element on and off during the operational state.

19. The method of claim 16, further comprising transitioning the dryer from the operational state to the standby state upon expiration of the interval of time.

20. The method of claim 16, further comprising maintaining the operational state of the dryer under the condition that the sensor senses another textile substrate on the conveyor belt prior to the expiration of the interval of time.
